(19) United States
(12) Patent Application Publication
(10) Pub. No.: US 2012/0106835 A1
(43) Pub. Date: May 3, 2012

(54) HYBRID VECTOR HALFTONE SCREENING AND ERROR DIFFUSION

(75) Inventors: Edgar A. Bernal, Webster, NY (US); Robert P. Loce, Webster, NY (US); Peter A. Crean, Webster, NY (US)

(73) Assignee: Xerox Corporation, Norwalk, NY (US)

(21) Appl. No.: 12/915,271

(22) Filed: Oct. 29, 2010

(51) Int. Cl. G06K 9/00

(52) U.S. Cl. 382/162

(57) ABSTRACT

Vector halftoning and error diffusion are combined to provide a quantization method that yields high quality rendered images while demanding fewer system resources. For instance, the method is tolerant of resolution reductions in secondary or auxiliary channels to the vector halftoning process. Accordingly, these secondary pixel data channels can be sub-sampled and/or bit-depth reduced for transmission bandwidth conservation and/or reduction in data storage requirements. Restoring the resolution of the low resolution channels provides estimated image data to arrange or align with high resolution target channel data for the vector halftoning process. Error from marking decisions generated by the vector halftoning process is diffused to neighboring unprocessed pixels. The method also allows for the use of a small vector halftone threshold array while providing quantized images with fine texture and wide color gamuts. In some embodiments error diffusion is distributed according to vector error diffusion.

### TECHNICAL FIELD

The present embodiments relate to image production systems. Embodiments include a technique for combining vector halftoning and error diffusion. In embodiments, sub-sampling or resolution reduction of selected color separations is well tolerated and provides improved efficiencies in bandwidth and memory usage. Data regarding a selected target pixel data or colorant channel or separation is transmitted at full spatial and bit-depth resolution and data regarding the other colorants or separations is transmitted at lower spatial and/or bit-depth resolution. The lower resolution data is used in performing vector halftoning/error diffusion. Pixel value alignment can be maintained, where needed, by up-sampling or re-sampling the low resolution channel(s) to a resolution in common with the target channel or separation.

### BACKGROUND

Digital images are commonly represented as one or more separations, with each separation conventionally represented as a monochromatic bitmap, which may be described as an electronic image with discrete signals, hereinafter referred to as pixels, defined by position and density. Monochromatic images typically are represented with a single separation while color images and documents commonly are represented as two or more separations with each separation or channel comprising a set of colorant density signals for a single colorant. Density is described as a value in a relatively large number of possible values. For example in 8 bit systems, density is often described as a value in the range of 0 to 255. Since 256 tonal values are available, the range of values is considered continuous and values in this range are referred to as contone values. Contone values are also referred to as gray levels, even when non neutral colorants are being discussed. Image rendering devices are often unable to produce a large number of gray levels at a given pixel position. Indeed many image production devices can only produce two shades of gray at a given pixel position, either on or off, marked or unmarked. The process by which contone values are converted to such binary values is referred to as quantizing or quantization. One class of methods for quantizing image data is referred to as halftoning. Another class of methods for quantizing image data is referred to as error diffusion.

In scalar halftoning, a color contone pixel is quantized to a marking decision or small set of marking decisions with regard to each of a set of color planes or separations (e.g., each of cyan, magenta, yellow and black). Each marking decision is based on a threshold value for a spatial position of the pixel in question, the particular color plane or channel and the contone pixel value of the pixel in that color plane or channel. The thresholds are arranged in a halftone screen. A different screen can be applied to each color plane or separation.

In embodiments of vector halftoning, a single (i.e., the same) stochastic screen can be applied to each channel. Pixel values in each channel or separation are considered together to select or determine one or more marking decisions. That is, in some instances, for example, the contone value of a magenta channel of a pixel can influence whether a mark is placed or made in the yellow or cyan color plane. A stochastic screen uses high ink density and a large number of dots to produce images. Stochastic screens eliminate moire from print fine lines, create smoother tint builds, facilitate unlimited spot color, and may correct an image which has been printed out of register. Vector halftoning with a stochastic screen can reduce problems with moire, reduces the amount of memory needed to store halftone screens, and provides better placement of dots from different separations. For instance, vector halftoning can be used to implement what can be called a successive filling algorithm. Successive filling is one way to provide better dot placement.

A simplified example of a successive filling algorithm can be described so that for each pixel, the separations are halftoned in the order darkest to lightest. Black color is processed first, then the screen is filled as a normal halftone. Next, one of the colors, such as cyan, is added. Locations that already have black dots are avoided. Then another color, such as magenta, is added. Locations that already have black or cyan dots are avoided. Finally, yellow is added.

Vector halftoning is well suited for ink jet marking because the tight, color-to-color registration capabilities in ink jet marking can be taken advantage of and the vector halftoning can produce finer textures. However, as indicated above, in vector halftoning, knowledge of the values within multiple color separations is required in order to decide on marking decisions within a given separation. This is not an issue for many ink jet printers because jets for the various colorants are in close proximity and image data being printed for any one channel is provided in close temporal proximity to image data being printed for another channel. This proximity allows for relatively small, low cost memory buffers to provide the information needed to perform vector halftoning.

Vector halftoning in an image path that has imaging stations for the different colorant planes at a significant temporal and or spatial separation, however, is expensive due to the need to provide large page buffers to align the data for the color planes because the different colorant values of CMYK for a given pixel can be printed at significantly different times. For example, in some systems, marks are made or toner is laid down first for one separation or color plane, then for a second, then for a third and so on. This means that image data for a cyan channel would not otherwise be available when marking decisions are being made for the magenta channel. However, as indicated above, in vector halftoning data from one channel can influence the marking decision made in another channel. In the past, this has implied the need for large buffers. In terms of memory capacity and system architecture, such processing has been prohibitively expensive and otherwise impractical.

One option is to perform vector halftoning in a Digital Front End (DFE) that provides the binary or quantized image to the printer. Typically, a DFE rasterizes the image from some page description language form and holds all color planes in memory simultaneously. Halftoning in the DFE avoids the cost associated with large amounts of high speed memory in the printer, which would be needed if the imaging stations are at a significant distance. However, the approach of halftoning in the DFE results in a serious limitation in the ability to maintain the calibration of a print engine. To maintain the calibration of a printer, it is desirable to apply adjustments to the values in the color channels to track the physical marking characteristics of a print engine as it varies in time. Continuous tone pixel values, such as 8 bit (0 to 255) values can be adjusted to maintain the calibration of the overall printing process. After quantizing is performed, pixel values within the channels are typically binary (0,1), and minor adjustment of a pixel level is difficult to perform.

As indicated above, image quantization techniques include halftoning via screening and error diffusion. These techniques determine or select marking decisions. Marking decisions can be binary, such as on or off, mark or no mark, or may be associated with high addressability pixels associated with a few additional quantization levels. In some ink-jet embodiments the analogous feature is to vary droplet sizes and/or vary droplet number. However, marking decisions are associated with fewer quantization levels than are continuous tone pixel values. Accordingly, selection of a set of marking decisions for an image results in a reduced quantization version of that image. Each class of technique has advantages and disadvantages as compared to the other class. At commonly available resolutions, halftoning can lead to visual artifacts. For instance, halftone cell repetitions often fall within a range of frequencies that are visually detectable. Error diffusion often results in marks being placed at a frequency and in a non-repeating manner that is less visible. However, error diffusion techniques can be associated with other objectionable phenomena.

In maintaining print uniformity and stability over time, one advantage of real-time contone image paths over binary image paths is that it is easier to apply control methods to contone pixels.

For reasons of bandwidth and memory, ink jet printers typically perform halftoning upstream of the print engine where colorant values from multiple separations are available and enable Vector Halftoning (VHT) methods to be used. A sub-sampled continuous tone, or contone, image path and corresponding Vector Halftone via screening may be employed to achieve controllability of a contone path, bandwidth efficiency, and high level of image quality due to fine texture and larger gamut provided by the vector method.

A drawback of using the VHT quantization method in a sub-sampled image path, is that the VHT method requires very large arrays or screen cells to achieve acceptable image quality and such large arrays consume large amounts of computer memory. An alternative to the VHT method is Vector Error Diffusion (VED) which is known to produce fine texture and large gamut without the need to store in memory a large halftone cell.

Error diffusion is a process which quantizes a target pixel and distributes error associated with the quantization of the target pixel to neighboring pixels that have not yet been processed.

As indicated above, error diffusion is a process which takes an image of continuous tone and converts it to, for example, a bi-level representation. The error diffusion process employs an algorithm which determines whether or not to print a mark at a certain location based on a comparison of the continuous tone data with a threshold value. Gray levels above a chosen threshold value might be assigned a dot to be printed, while gray levels below the threshold value might not be assigned a dot to be printed. If the threshold corresponds to midway between black and white, the method always chooses the closer of black and white. The inherent error resulting from such a choice is propagated in specified amounts to neighboring pixels prior to their thresholding. This method can produce a more accurate representation of a gray tone over a small area encompassing several dots than conventional halftoning. Hence, the error in the intensity of the digital image is diffused and, on average, is zero. The fraction of the error added to each adjacent pixel can be weighted, with the total error or remaining error being multiplied by the weight corresponding to a given adjacent pixel and then added to a value of that adjacent pixel. The choice of weight can affect the image quality.

As used herein, scalar refers to quantization techniques which consider only a single value from a given pixel when making a marking decision regarding that value of that pixel. For example, scalar error diffusion techniques can be applied separately to each separation of a color image. For instance, where each pixel of a contone version of an image describes a small portion of the image in terms of colorant densities of cyan, magenta, yellow and black colorants, a scalar form of error diffusion makes marking decisions regarding the cyan colorant without considering the values of the target pixel associated with the other colorants, such as magenta, yellow and optionally black. Similarly, a marking decision is made with regard to the magenta colorant without considering the values of the pixel related to the cyan, yellow and black colorants.

In vector error diffusion, contone values regarding a first colorant, such as cyan, can have a bearing or be a factor in a marking decision associated with a second colorant, such as magenta. Indeed, all the values of a particular pixel may be considered when making a marking decision regarding a particular colorant. That is, in vector error diffusion, colors are treated as points in a multi-dimensional color space with the colors printable or displayable located at discrete reference locations within that space. When a continuous tone or contone color is to be displayed, for example, the closest displayable color can be selected for display, with color error being calculated as a vector in the color space and diffused to neighboring pixels.

Vector error diffusion treats color as points in a three dimensional space, with the colors printable or displayable at a given pixel discrete locations within that space. When a continuous tone color is to be displayed, the closest displayable color is selected. The vector is the difference between the desired color and the available color. An error is calculated as the quantifiable difference between the input color and the desired output color. The vector error is calculated as a vector in color space and may be the simple distance in color space or a weighted distance based on the human visual model. The vector error is then diffused among the adjacent pixels in the same manner as is done in normal error diffusion. The color chosen for each pixel is the color in a selected color space closest to the desired value, where the desired value is the input value modified by the errors diffused from neighboring pixels. This tends to confine the pixel colors to a subset near the input value and reduces image noise.

A drawback to using VED in a sub-sampled image path is that such VED can produce a coarse image texture. Thus, there exists a tradeoff between VHT and VED texture, with VHT offering image quality at the cost of significant bandwidth or storage requirements, while VED demands less memory or bandwidth at the cost of coarse image texture.

What is needed in the art is a means to solve the problem of achieving the bandwidth efficiency of a sub-sampled cross-channel image path, combined with the fine texture of VHT or a conventional VED, while also avoiding the storage requirements of very large arrays required to store a halftone cell.

Co-pending patent application Ser. No. 12/577,798 filed Oct. 13, 2009, entitled “Vector Error Diffusion with Edge Control,” by Bemal et al., describes vector edge diffusion related to the quantization and transformation of continuous tone images data for rendering on reduced quantization devices such as an LCD. The disclosure is directed primarily at image edge enhancement and is included herein by reference in its entirety.

Co-pending patent application Ser. No. 12/258,871, filed Oct. 27, 2008, entitled “Image Path Utilizing Sub-Sampled Cross-Channel Image Values,” by Crean et al., describes an image path architecture for performing cost-effective cross-channel image processing. For generating the output value of a given colorant (e.g., cyan), the method utilizes pixel data for that colorant at its nominal or full resolution, while pixel data for other colorants is utilized at a lowered resolution. For instance, color-corrected pixel values for cyan can be obtained by inputting cyan pixel values at nominal resolution into a multi-dimensional LUT, and the values for the other color dimensions are input using sub-sampled values, such as JPEG DC coefficients or Display Resolution Image pixel values. Using the nominal or full resolutions for cross-channel processing would require a 300% increase in bandwidth for each output color, while the aforementioned disclosure utilizes JPEG DC coefficients requiring only a 4% increase. Similar gains are obtained in image buffering. This disclosure however, employs a look-up table which must be stored in computer memory and is thus memory intensive. Co-pending patent application Ser. No. 12/258,871 is included herein in its entirety.

### Incorporation by Reference

The following patents and patent publications are totally incorporated herein by reference in their entirety.

U.S. Pat. No. 7,095,530 by Mantell, et al., titled “Color Vector Halftoning Using a Successive-Filled with Improved Color Registration”.

U.S. Pat. No. 6,501,567 by Sharma, et al., titled “Method and System for Designing Spatially-Partitioned and Correlated Stochastic Screens for Color Halftoning”.

U.S. Pat. No. 5,045,952 by Eschbach, titled “Method for Edge Enhanced Error Diffusion”.

U.S. Pat. No. 5,621,546 by Klassen et al., titled “Method and Apparatus for Vector Error Diffusion with Output Color Control”.

### BRIEF DESCRIPTION

The present application solves the VHT versus VED tradeoff problem by presenting hybrid multi-dimensional VHT/ED sub-sampled halftoning systems and methods that do not require very large halftone arrays and the associated memory necessary for storage. Target colorant channel pixel data is received at nominal or full resolution, while pixel data for other colorants is received at lower resolution and up-sampled to a common resolution. For a given pixel, a VHT step is applied to obtain a thresholded pixel value or marking decisions for the target pixel data channel. Color error from the vector thresholding process is diffused onto neighboring pixels. Error values can be buffered before being combined with neighboring pixel values. The process is repeated for other pixels of interest and for other colorant channels.

For example, a method for quantizing color image data of an image, the method can include selecting a target pixel data channel from a plurality of pixel data channels of the image data, combining pixel data of the image with color error values generated from a vector halftoning of at least one previously processed pixel, thereby generating combined pixel data, vector halftoning the selected target pixel data channel of the combined pixel data, according to pixel data of at least one non-target pixel data channel of the image, thereby transforming the color image data of the image into marking decisions for the target pixel data channel and diffusing color error produced in the vector halftoning process for combining with unprocessed pixels neighboring each respective vector halftoned pixel.

Some embodiments that take advantage of a provided tolerance of reduced data resolution include methods for quantizing color image data of an image that include selecting a target pixel data channel from a plurality of pixel data channels of the image data, transmitting pixel data of the image in the target pixel data channel at a nominal resolution, reducing the resolution of pixel data of at least one non-target pixel data channel of the image, thereby generating low spatial and/or bit-depth resolution pixel data relative to the nominal resolution of the target pixel data channel, transmitting the low resolution pixel data, receiving the transmitted target colorant pixel data, receiving the transmitted low resolution pixel data, restoring the resolution of the low resolution pixel data to the nominal resolution, thereby providing arrangeable data in the at least one non-target channel to align with the nominal resolution data in the target pixel data channel, arranging the arrangeable data with the target channel pixel data, thereby producing arranged pixel data, combining the arranged pixel data with the diffused color error values generated from a vector halftoning of at least one previously processed pixel, thereby generating combined pixel data, vector halftoning the selected target pixel data channel of the combined pixel data, according to pixel data of at least one non-target pixel data channel of combined pixel data, thereby transforming the color image data of the image into marking decisions for the target pixel data channel and diffusing color error produced in the vector halftoning process for combining with unprocessed pixels neighboring each respective vector halftoned pixel.

In some embodiments, vector haiftoning the selected target pixel data can include using a small threshold array. For instance some embodiments use a 16×16 array of stochastically arranged thresholds having values ranging within the range of 0 to 255, non-inclusive. For example, some embodiments include vector halftoning the selected target pixel data using a 16×16 array of stochastically arranged thresholds having values ranging within the range of 64 to 191 inclusive.

### BRIEF DESCRIPTION OF THE DRAWINGS

FIG. 1 illustrates signal flow of image data including resolution reduction of non-target channels.

FIG. 2 illustrates the signal flow of FIG. 1 applied to a vector based image quantization process.

FIG. 3 is a block diagram of aspects of the vector based image quantization process of FIG. 2.

FIG. 4 outlines a vector based quantization process using sub-sampled or reduced resolution for transmission of non-target image data.

FIGS. 5A-5D illustrate image rendering results of a plurality of image quantizing processes with FIG. 5D illustrating rendering results based on an embodiment of the process of FIG. 4.

FIG. 6 illustrates a contone color patch and example renderings of related data based on two quantization methods ion of the methods being an embodiment of the method of FIG. 4.

### DETAILED DESCRIPTION

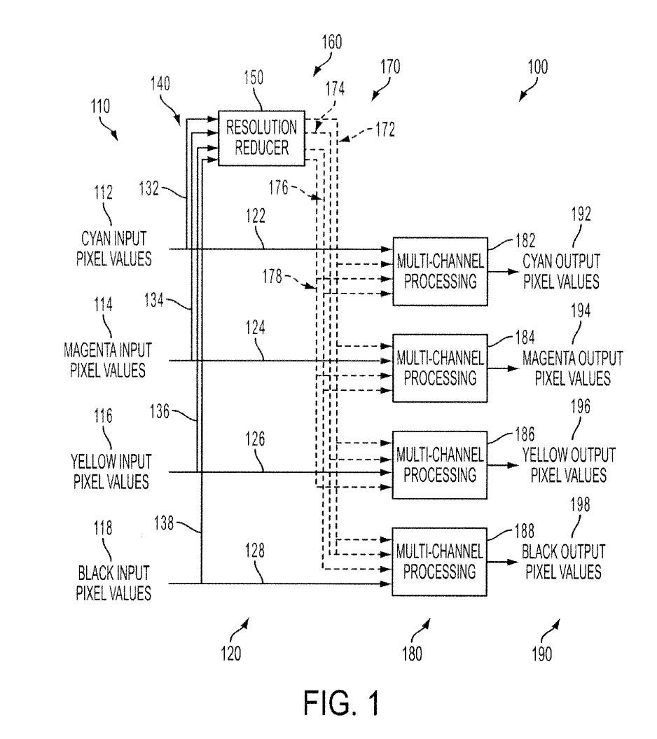

Referring to FIG. 1, an image (not shown) is comprised of pixels. Each pixel includes a set of values that describes a tone or color of a small portion of the image. The image may have been, for example, generated through employment of a scanner, camera, document or image authoring tool, or received via the Internet or computer network. For instance the pixel value may be colorant values that call for a particular density of colorants that together describe a color such as, for instance, orange, green, violet, light cyan, light magenta, gray, dark yellow, white, and flesh tones. One embodiment described here uses colorant values 110, CMYK of cyan 112, magenta 114, yellow 116, black 118 colorants. Other colorant values might be used in addition to or as an alternative to these CMYK colorants. Alternatively, pixel data can be communicated in a device-independent color space. For example, the pixel values might describe a color in terms of L*, a* and b* of the CIE Lab color space. Pixel values are communicated at a full or nominal spatial and/or bit-depth resolution to respective multichannel processors 180. For example, full resolution cyan 122, magenta 124, yellow 126, and black 128 are depicted as being provided to respective multi-channel processors 182, 184, 186, and 188.

In order to reduce bandwidth demands and/or memory storage requirements, and because a multi-channel processing method has been identified that produces high quality output even when provided with low resolution data on some channels, the multi-channel processors 180 are depicted as receiving low resolution data (dashed lines) from their respective non-target channels. The low resolution data is depicted as being provided by a resolution reducer 150. The resolution reducer 150 is depicted as receiving CMYK pixel values (112, 114, 116, 118) through lines 132, 134, 136, 138 at input 140 and delivering reduced resolution data on lines 172, 174, 176, 178. Resolution can be reduced by, for example, sub-sampling and/or bit-depth reduction.

Sub-sampling generates a lower spatial resolution signal from a nominal signal by extracting only a portion or a sample from the nominal full resolution signal. Such a low resolution sub-sample is obtained for each colorant by, for example, calculating averages of N×N windows in the image. For example, it has been found satisfactorily to use N=8. Other values may also be employed depending upon the application. The low resolution sub-sample may also be obtained by regular sub-sampling picking one pixel value out of the set of N×N pixels in the window. An example would be to send the low resolution signal at the start of every 8^{th} scan line. Such technique of reducing the number of samples in a discrete time signal is known as decimation. Alternatively, averaging with weighted values prior to sampling may be employed to derive the sub-samples. Other order-static methods may be used to derive the sub-samples, such as using the maximum value, median value, or minimum value within the N×N window as the sub-sample value. Another alternative is to use the value derived as a result of other operations such as JPEG compression which calculates the DC value of every 8×8 pixel window. Thus, if the printing engine is processing the cyan value C at full resolution, it will have averages for M and Y across the corresponding N×N window in which the C pixel is located. Thus, if the full resolution pixel C has a spatial location in an 8×8 window, the print engine will have available the spatially averaged value of the block going from row 1 to row 8 and from column 1 to column 8, and correspondingly for the averages of the Y sub-sample pixel values. Listed are some, but not all, of the manners in which sub-sampling may be performed. Other sub-sampling techniques in the art may also be employed.

The resolution reducer 150, with regard to sub-sampling, can operate in a simple independent channel manner, but it could also take into account all channels when sub-sampling. The low resolution sub-sample is obtained for each colorant by, for example, calculating averages of N×N windows in the image and it has been found satisfactorily to use N=8, but it will be understood that other values can be employed depending upon the application. The low resolution sub-sample may also be obtained by regular sub-sampling picking one pixel value out of the set of N×N pixels in the window, which is also known as decimation. Alternatively, averaging with weighted values prior to sampling may be employed to derive the sub-samples. Other order-statistic methods may be used to derive the sub-samples, such as using the maximum value, median value, or minimum value within the N×N window as the sub-sample value. Another alternative is to use the value derived as a result of other operations such as JPEG compression which calculates the DC value of every 8×8 pixel window. The values for any needed sub-sampled channel can be provided using JPEG DC coefficients. Display Resolution Image pixel values are generated as part of XM2, or JPEG2000 wavelet sub-bands.

Another alternative is to employ JPEG2000, which is a common image compression format, as a source of sub-sampled image data. JPEG2000 transforms the image into a set of two-dimensional sub-band signals, each representing the activity of the image in various frequency bands at various spatial resolutions. Each successive decomposition level of the sub-bands has approximately half the horizontal and half the vertical resolution of the previous level. A reverse decomposition module within the sub-sampler can reverse as many decomposition steps as necessary to obtain a low resolution version of the original image with resolution equal to the desired sub-sample spatial resolution utilized in the multi-dimensional mappings.

Bit-depth reduction is achieved by mapping the contone grayscale values of the nominal, full bit-depth signal onto a smaller set of values whose binary representation requires a shorter sequence of binary values. For instance, in an 8-bit image path, the nominal signal can take on values ranging from 0 to 255. The signal resulting from the bit-depth reduction process to a bit depth of b bits, where b<8 can take on values ranging from 0 to 2^{b}-1. Bit-depth reduction can be achieved by, for example, keeping only the b most significant bits from the binary string that represents the gray value of the input pixel. For example, a gray value of 200 is represented by the 8-bit binary string 11001000. Its corresponding 5-bit binary string would be 11001, or, equivalently, a gray value of 25. Note that this procedure maps all input gray values between 200 and 207 to the same 5-bit string, namely 11001.

A lower bit-depth representation with b bits can also be achieved by grouping the input gray values into 2^{b} intervals of possibly different lengths, and mapping all the values that fall inside a given interval or bin to a binary string of length b that has been previously assigned to that particular bin. For instance, if b=2, a possible set of bins could correspond to the intervals [0, . . . , 31], [32, . . . , 63], [64, . . . , 127], and [128, . . . , 255]. According to this bit-depth reduction scheme, any input gray value that falls in the range [64, . . . 127] would be assigned the 2-bit binary string 10.

The transmission of pixels occurs, for example via a serial communications link. To process a pixel, information regarding a plurality of the color values of the pixel needs to be available to the multi-channel processor (e.g., one of 182-188) at the same time. However, the color pixels need not be transmitted at the same time. The pixel colors at low resolution and the pixel colors at high resolution may be transmitted at different times. On a fine grained image with few scan lines, the data for all colors is mixed in and early arriving data is then processed as the last color arrives. The low resolution data can be transmitted/received first and stored in buffer memory since it takes a lot less storage than high resolution data. Under this scenario, the buffered low resolution data is processed as the high resolution color is received. This is beneficial, particularly in systems that render each color separation at separate times or at separate stations and/or do not otherwise communicate all or plural ones of a pixels values at the same time.

In some embodiments, the multi-channel processors 180 may not need all the channels shown. One or more of cyan 182, magenta 184, yellow 186, and black 188 might not be needed by a particular processor 182, 184, 186, 188 in order to generate output respective output values 190 for cyan 192, magenta 194, yellow 196, and black 198.

According to an aspect of the presently described embodiments, the multi-channel processors provide resolution reduced vector halftoning. That is, for a given target colorant or pixel value channel, pixel data is received and used at its nominal, full spatial resolution. Pixel data for other (non-target) colorants or pixel data channels can be received at a lower resolution in order to conserve communication bandwidth and/or memory.. For example, quantized pixel values or marking decisions for cyan can be obtained by inputting contone cyan pixel values at nominal resolution into a vector halftoner, while values for the other color separations are input using sub-sampled values, such as an average of a block of pixels surrounding a target pixel, JPEG DC coefficients, or Display Resolution Image (DRI) pixel values and/or are input using bit-depth reduced values.

Traditionally, regular sub-sampled vector halftoning uses large screens or arrays of 256×256 thresholds to achieve acceptable image quality. The method proposed here offers the advantage of producing comparable results using only a small threshold array.

As indicated above, the method of quantizing image data described herein includes vector halftoning and error diffusion. This combination of processes allows for resolution reduction of some of the needed data.

According to the reduced resolution architecture, pixel data for the target colorant is received at nominal or full resolution, while pixel data for other colorants that have a bearing on the marking decision or quantization value for the target colorant can be resolution reduced and received by the respective multi-channel processor at lower resolution. While from a data precision standpoint these non-target channels can be transmitted and received at a low spatial resolution, from a data arrangement or alignment standpoint, for each pixel value in the target channel there needs to be a corresponding value at a corresponding bit-depth in each of the non-target channels being considered. Accordingly, each of the channels received at a low resolution is resolution restored to a common resolution, e.g., a resolution at which the target pixel data channel is to be processed.

For instance, small-array vector halftoning can be applied to the target channel of a target pixel to obtain a thresholded or quantized pixel value or marking decision for the targeted pixel/channel. Error from the marking decision selection/quantization is diffused onto values of neighboring pixels. The process is repeated for values of other pixels of interest in the target channel and for other colorant channels when the other colorant channels are processed as the target channel. In this regard, it is noted that, while FIG. 1 depicts 4 multi-channel processors 182-188 and might be construed to depict parallel processing, in many embodiments, processing of one target channel can be delayed or out of phase with the processing of another target channel.

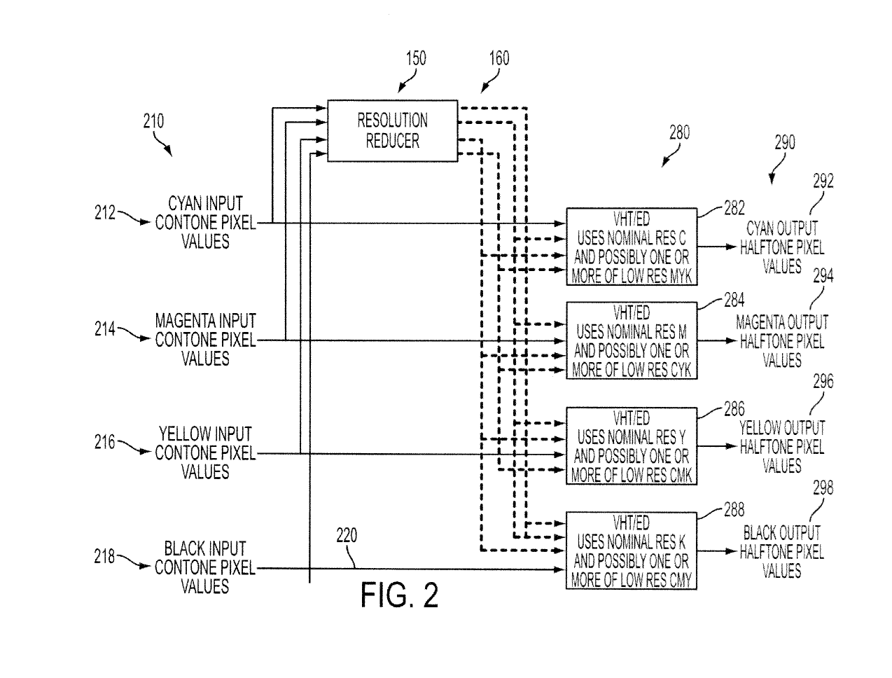

Referring to FIG. 2, the multi-channel processors 180 can be vector halftoning/error diffusing processors 280. For a targeted colorant channel 210, pixel data for a one selected targeted color (colorant cyan 212, magenta 214, yellow 216, or black 218) is received at nominal full resolution 220, while pixel data for other non-selected or targeted colorants are received at a substantially lower resolution and resolution restored to a common resolution in the vector halftoning/error diffusing processors 280.

When resolution is reduced by sub-sampling, the sub-sampling rate used in the sub-sampler need not be the same for all colorant channels. Similarly, when bit-depth reduction is applied, the target bit depth b need not be the same for all colorant channels. For example, since the human visual system has low acuity for yellow, the yellow or Y channel could be sampled at a lower spatial resolution or reduced to a smaller bit-depth than the other channels without incurring a significant loss in perceived image quality. Also, not all channels need to be passed to each VHT/ED processor. The channels required by each module are dependent upon the specific vector halftoning/error diffusion method that is employed. The sub-sampling could be performed as simple averaging or weighted averaging, by the sub-sampling techniques mentioned previously, or by other sub-sampling methods old and well known in the art.

Within the vector halftoning/error diffusion module 280, the low resolution image data is associated with the nominal resolution data such that pixel-resolution error diffusion can be applied. That is, the low resolution data is “up-sampled” and/or bit-depth restored within the VHT/ED module 280.

If used, the “up-sampling” can be of a variety of forms. For example, the same low resolution value can be used repeatedly as a value of a block of pixels. Alternatively, interpolation techniques, such as linear, quadratic, or cubic interpolation can be applied between spatially neighboring low resolution samples in order to generate estimated pixel values at the nominal resolution.

If used, the bit-depth restoration can be of a variety of forms. Although the bit-depth reduction process is irreversible since it is a many-to-one mapping, approaches that minimize a cost function between the restored and the original data, thereby providing an estimate of the original value can be implemented. For example, if the intent is to minimize the maximum possible value of the quantization error, every b bit string can be mapped to the mid-point or median value of the bin or interval of original values to which it corresponds. The same mapping choice can be used when the intent is to minimize the mean squared error (MSE) between the original and the restored signal and the original signal is known to be symmetrically distributed about the mid-point of the interval corresponding to the bin. Examples of such distributions include the uniform and the normal or Gaussian distribution. When the distribution is not symmetric, the mapping choice that minimizes the MSE can be the mean or average of the distribution that characterizes the statistical behavior of the values of the original image within each bin.

Once associateable pixel values are available for all the separations of interest for a target pixel, a vector halftoning can be applied to the target pixel to obtain a thresholded pixel value or marking decision for the targeted colorant channel of the target pixel. As indicated above the thresholding or halftoning can be performed according to an array or halftone cell. For instance the cell can contain a stochastically arranged set of threshold values. In some embodiments, where contone values are limited to a set of values ranging from 0 to 255, the stochastically arranged threshold values can be limited to a range of values smaller than [0,255] (that is above 0 and less than 255). Limiting the range of threshold values tends to reduce visual artifacts due to the array and therefore allows a smaller array to be used. If a simple constant threshold is used instead of a more random distribution of threshold values, any detailed image structure that is not well represented in the low resolution image data can result in uncontrollable displacements between the dots for the various colorants. Visually, a resulting output image might include coarse textures and have a smaller color gamut than vector error diffusion typically produces. Use of a modulated threshold maintains the phase position of dots between the color planes.

The threshold array used in this combined vector halftoning/error diffusion quantization method can be smaller than that typically used in quatization methods based on vector halftoning alone. For example, in embodiments of the methods disclosed herein, a stochastic threshold array of size 16×16 produces image quality similar to that provided by using a 256×256 in vector halftoning alone.

A variety of threshold array configurations can be used. As an alternative to a pseudo-random or stochastic threshold distribution, a functional form of threshold may be used, such as, for example, a sine-type function. It has been found that a stochastic array with threshold values in a a range of [64,191], in systems where contone values range from 0 to 255, produces images of good image quality. It is contemplated that optimization of threshold values might allow the range of values to be further reduced, thereby allowing the use of fewer bits/threshold.

As has been indicated above, in vector halftoning, a marking decision in one channel can be influenced by values of image data in a second channel. The following is an illustrative example of one vector halftoning technique aimed at producing dot-off-dot marking decisions.

For example, cyan, magenta, yellow, and black input color values C₁, M₁, Y₁, K₁ are received. For instance C₁ might be received at full or nominal resolution and M₁, Y₁ and K₁ might be the result of up-sampling of data received at a lower resolution. All the values might be the result of received data to which error from one or more previously processed pixels has been added or combined. For instance, the input color values C₁, M₁, Y₁, K₁ might be transformed to cyan, magenta, and yellow color values C, M, Y, in such a manner that each of C, M, Y is not greater than a predetermined maximum color value such as 255 (for example for 8-bit color values):

C=C₁+K₁

M=M₁+K₁

If C>255, set C=255

If M>255, set M=255

If Y>255, set Y=255

For calculation and decision purposes, a blue value 8 for overlapping cyan and magenta defined and is initialized to zero (0), and cyan and magenta output colorant values Cₒᵤₜ, Mₒᵤₜ are initialized to the cyan and magenta values C, M:

B=0

Cₒᵤₜ=C

Mₒᵤₜ=M

A determination is made as to whether C+M is greater than 255. If not, processing moves directly to a halftoning stage.

If the determination is yes, C+M is greater than 255, values for B, Cₒᵤₜ, and Mₒᵤₜ are calculated, for example such that B+Cₒᵤₜ+Mₒᵤₜ=255:

B=C+M−255

Cₒᵤₜ=255−M

Mₒᵤₜ=255−C

The equation B+Cₒᵤₜ+Mₒᵤₜ=255 is based on having no white space since C+M>255. The Equation B=C+M−255 identifies the overlapping cyan and magenta dots as being the amount of C+M that exceeds 255. The foregoing illustrative expressions for Cₒᵤₜ and Mₒᵤₜ also satisfy the equations C=B+Cₒᵤₜ and M=B+Mₒᵤₜ, which can provide for printing of the total number of cyan and magenta dots requested by the CMYK color data.

Halftoning or marking decision selection is performed using for example using a stochastic halftone threshold array A1 having a threshold value t for each pixel limited to a range smaller than [0, 255] for blue, cyan and magenta, and a stochastic halftone threshold array A2 having a threshold value t′ for each pixel limited to a range smaller than [0, 255] for yellow, for the illustrative example wherein the predetermined maximum color value is 255.
If B>t, cyan, magenta dots are on
Else if B+Cₒᵤₜ>t, cyan dot is on
Else if B+Cₒᵤₜ+Mₒᵤₜ>t, magenta dot is on
If Y>t′, yellow dot is on

The threshold arrays A1, A2 can be correlated or uncorrelated. By way of illustrative example, the threshold array A2 can be derived by shifting the threshold array A1 by a predetermined number of pixels, whereby the threshold array A2 is a replica of the threshold array A1 that is shifted relative to the threshold array A1 by a predetermined number of pixels. Where A2 is a shifted version of A1 , the correlation between A2 and A1 decreases as the shift increases.

The procedure outlined above is illustrative only. Other vector halftoning methods can be applied. For example, magenta can be tested in combination with blue as indicated below:
If B>t, cyan, magenta dots are on
Else if B+Mₒᵤₜ>t, magenta dot is on
Else if B+Mₒᵤₜ+Cₒᵤₜ>t, cyan dot is on
If Y>t′, yellow dot is on

Color error generated by or associated with the vector halftoning based marking decisions can be diffused into buffers. Color error from the vector thresholding process is diffused onto neighboring pixels values that might be buffered or which might be received subsequently. In the illustrative embodiment, marking decisions are output 290 as halftone pixel values for cyan 292, magenta 294, yellow 296, and black 298. Other colors spaces such as, but not limited to Lab, CMYK and RGB, are also known to be used within vector halftone and error diffusion. These other color spaces are also relevant to the present embodiment and would have a similar set of operations and data flow. While FIG. 2 depicts 4 vector halftoning/error diffusing processors 282-288 and might be construed to depict parallel processing, it is to be noted that in many embodiments, processing of one target channel can be delayed or out of phase with the processing of another target channel. Channels might also be processed sequentially by a single processor.

In some embodiments the error diffusion can be a form of vector error diffusion wherein the error associated with the marking decision made for each channel of a pixel is considered in combination as an error vector and diffused accordingly. For instance, if the marking decisions for a pixel result in positive errors in each of a cyan, magenta and yellow channels, instead of diffusing error to the related channels in neighboring pixels, an error corresponding to some of that error might be distributed to a black colorant channel of the neighboring pixels. In some embodiments, the pixel data might not be colorant data. For example, the pixel data might describe colors in terms of a perceptual color space. For instance, pixel data channels might include or might be converted into parameter values of the L*a*b* perceptual or machine independent color space. Error can be diffused, distributed or propagated in terms of such a color space. Subsequently, such values can be converted into a machine dependent color space based on a calibration or known or estimated characteristic of a particular machine. In such embodiments, the error might be considered as a vector and vector error diffusion might be used to distribute such error.

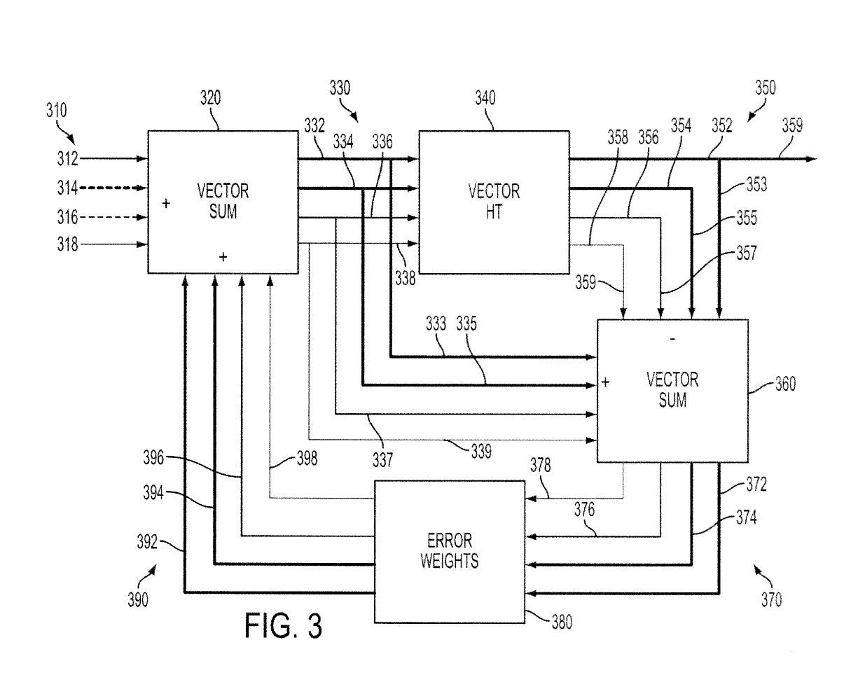

FIG. 3 outlines the interactions between the vector halftoning and error diffusion aspects of embodiments of the quantization process. For instance, FIG. 3 may be considered to outline the operation of vector halftoning/error diffusing processor 288. Pixel data 310 for K is received at nominal resolution into a vector summing module, while pixel data for other colorants black 312, cyan 314, magenta 316 and yellow 318 is received at lower resolution. The summing module 320 resolution restores the received low resolution pixel data to a common resolution (e.g., the nominal resolution of the K channel), as previously discussed. Weighted error for the colorants as determined from previous thresholding is then added to the received (K) and up-sampled (e.g., C, M and/or Y) pixel values. The weighted error for K is the actual error incurred in K due to the thresholding operation. The error for the other colorants is an estimate of error that will occur in the other channels (e.g., in similar processing that occurred, will occur or is occurring in similar processors 282-286 or previously occurred or will occur in the same processor). The error values are estimates because resolution restored values (i.e., estimates) are used to estimate output values for those colorants rather than using the actual high resolution values

The summed pixel values 330 are passed to a vector halftoning module 340, which performs thresholding using a modulated threshold signal, such as that provided in the 16×16 array discussed above, for each colorant of black 332, cyan 334, magenta 336 and yellow 338. The colorant values 330 are also passed to a vector sum module 360 as black 333, cyan 335, magenta 337 and yellow 339. The threshold value or signal can be the same (e.g. A1) for two or more channels, or the signal for one channel may be derived from the first (e.g., A2). That is, one threshold array may be used for more than one channel, where the array may be identical, have scaled values, have offset values, and/or inverted values. This modulated thresholding tends to distribute output pixels from the various channels to achieve the benefits of fine texture and large gamut. As described above, one simple method to perform the thresholding is by performing comparisons to a small threshold array. The vector halftone module will output 350 marking decision for the colorants of black 352, cyan 354, magenta 356 and yellow 358, with an actual marking decision output value for the target separation (e.g., K in this illustration) at the nominal resolution, and estimates the output values for the other channels, also at the restored nominal resolution. The vector halftone method used could be any appropriate vector halftone method.

The output values, actual and estimated, can be input as black 353, cyan 355, magenta 357 and yellow 359 to a differencing module 360 along with the output 330 of the first vector summing module 320. The difference 370 will be a vector error between the input values 330 and the output threshold values 350. In the case of K, the error will be the actual full nominal resolution 351. For the other colorants of black 392, cyan 394, magenta 396 and yellow 398, the error will be estimated.

Even though the input data from colorants other than K are input at lower resolution, the error within the module can be stored at full resolution, (full resolution data is depicted with solid lines in the Figures). Error diffusion usually requires buffering of some form of image data neighboring the target pixel being processed so that error can be diffused onto those pixels. It is typical to buffer modified pixel values, which are the original pixel values combined with error that has been propagated onto those pixels. However embodiments of the methods disclosed herein can buffer propagated error rather than buffer the modified pixel values. This approach enables the pixel data to be independent of the timing for receiving full resolution data and low resolution data from an image data source. If modified pixel values are buffered when processing a line at the bottom of a block boundary, it would be necessary to pull in a new resolution reduced line to engage the block below as well as encasing the resolution reduced data for the line being processed. This may be an issue in some processing settings. Buffering the propagated error instead of buffering the modified pixel values avoids this concern. The buffered error can be combined with the appropriate pixel values when they become available.

In the “error weights” module 380, the signals 370 for black 372, cyan 374, magenta 376 and yellow 378 are received from the vector sum module 360 and the error is divided into portions that will be summed onto various neighboring pixels 390 of each individual pixel colorant black 392, cyan 394, magenta 396, yellow 398 according to selected weights or percentages. The weights are associated with pixel positions relative to the target pixel associated with the error.

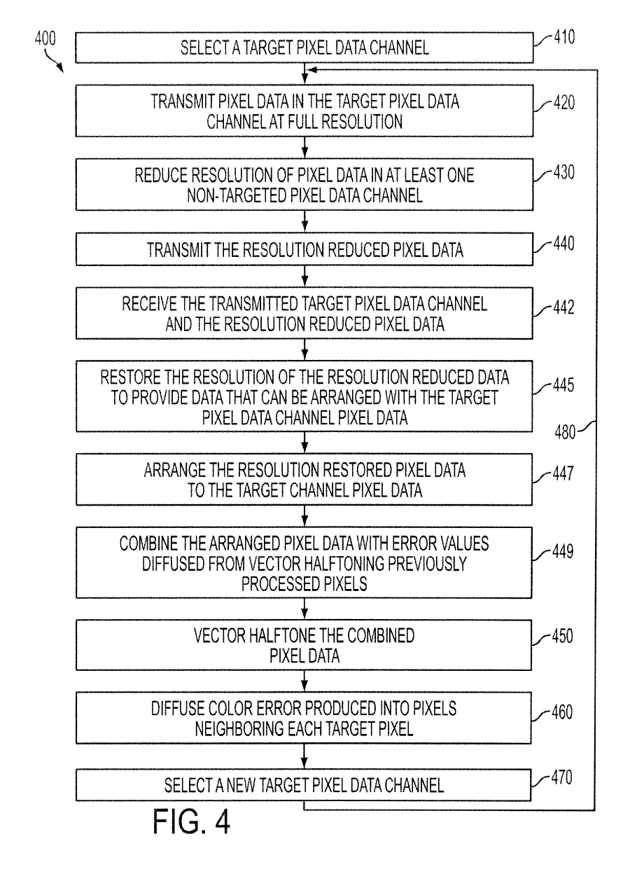

Referring to FIG. 4, in summary a method 400 for quantizing image data is provided. The method combines vector halftoning and error diffusion in a manner that is tolerant of reductions in resolution for some channels of image data used in the vector halftoning/error diffusion process. This tolerance reduces bandwidth and/or memory requirements for image processing systems (e.g., 100, 200) while maintaining a high level of rendered image quality.

The method includes selecting 410 a target colorant separation or channel, sending or transmitting 420 pixel data of the image in the target pixel data channel at full or nominal resolution to, for example, a multi-channel processor (e.g., 180, 280), resolution reducing 430 pixel data of the image of at least one other separation or channel, thereby generating low resolution pixel data relative to the resolution of the target channel of the at least one other separation or channel, sending or transmitting 440 the low resolution pixel data to, for example the targeted multi-channel processor e.g., 180, 280), receiving 442 the transmitted target colorant pixel data and the transmitted low resolution pixel data, resolution restoring 445 the low resolution pixel data to provide data in the at least one other or non-target channel to arrange with the full or nominal resolution data in the target channel, arranging 447 the resolution restored data with the selected 410 target channel pixel data, thereby producing arranged pixel data, combining 449 the arranged 447 pixel data with error values diffused from at least one previously processed pixel, thereby producing error combined pixel data, vector halftoning 450 the selected 410 target pixel data channel of the combined 449 pixel data according to the arranged 447 other channel data and diffusing 460 color error produced in the vector halftoning process into unprocessed pixels neighboring to each respective target pixel. The process can be applied to other separations or channels of the image pixel data by selecting 470 another target colorant channel as the target colorant channel and repeating 480 the process for the newly selected target channel. Doing so, changes the role of the various channels. For example, if cyan is selected as the target channel, then magenta might be included in the at least one other channel that is/are resolution reduced, transmitted and up-sampled. However, if or when magenta is selected as the target channel, cyan might be included in the at least one other channel that is/are resolution reduced, transmitted and resolution restored. It is anticipated, as indicated in FIG. 2, that the process is applied to each channel of the pixels of interest resulting in the transformation of contone image data of the image into marking decisions for rendering or printing a quantized version of the image. In some embodiments, the marking decisions are used to control a printer or marking device to produce a printed or rendered version of the image. In some embodiments, the quantized image might be rendered on a display screen or device.

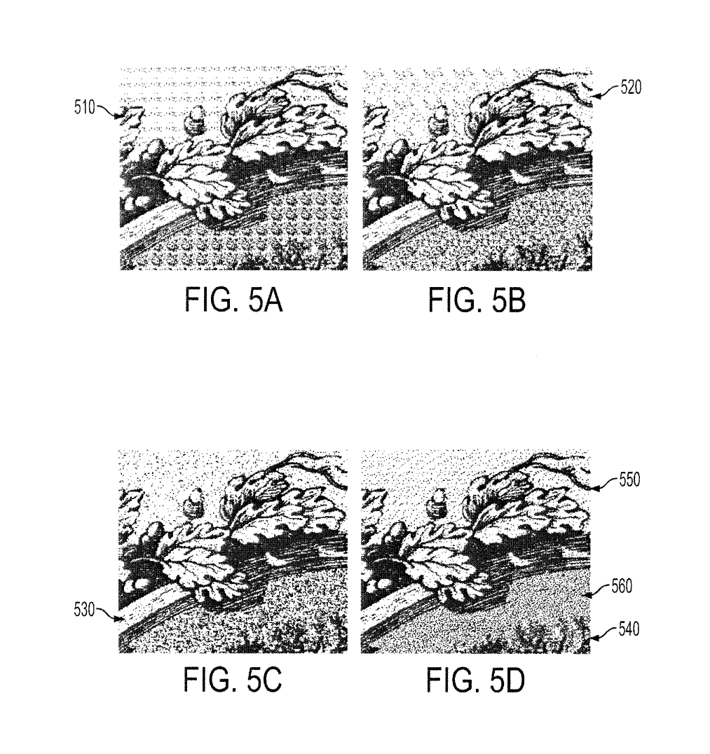

FIG. 5A represents a magnified black and white view 510 of an image portion of a color image printed after quantizing contone image data using only vector halftoning based on a 16×16 threshold array. FIG. 5B represents a magnified view 520 of the image portion printed after quantizing the contone image data using only vector halftoning based on a 32×32 threshold array. Note that view 510 includes distinct visually displeasing horizontal linear artifacts. View 520 represents an improvement but still includes noticeable vertical wavy patterns in, for example the upper left quadrant of the view. FIG. 5C represents a magnified view 530 of the image portion printed after quantizing the contone image data using only vector halftoning based on a 64×64 threshold array. While some serpentine patterning is still perceptible in this magnified view, the patterning is less pronounced and the image quality is improved over that of the views 510 and 520 of FIGS. 5A and 5B. FIG. 5D represents a magnified view 540 of the image portion printed after quantizing the contone image data according to an embodiment of the hybrid vector halftoning/error diffusion method 400 wherein vector halftoning was performed using a 16×16 scaled threshold array. Note that view 540 includes the least patterning and provides the most visually pleasing of all the views. For example, regions 550 and 560 are rendered with a more even distribution of colorant and with less perceivable patterning.

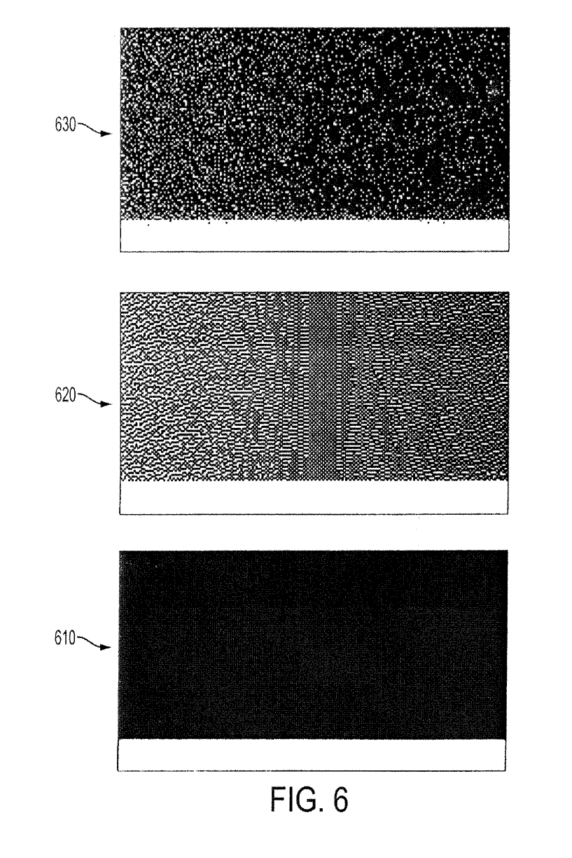

FIG. 6 demonstrates the image quality performance of an embodiment of the present method 400 as compared to that of a known vector error diffusion algorithm used in a sub-sampled cross-channel image path. While depicted in black and white, the images (710, 720, 730) represent renderings of a blue test patch. A continuous tone input image of a blue 710 is based on image data wherein both cyan and magenta are placed in exactly equal value and represents the input data to a the processes which generated the other views (720, 730).

The binary image 720 resulted from the application of the vector error diffusion applied to sub-sampled data for a decimation factor of 8. Since both input channels to the process were identical, the resulting halftoned cyan and magenta halftone images are identical. This resulted in blue dots (cyan/magenta overprint dot-on-dot) with a significant portion of the image area unmarked so that the white background is often visible in the image area.

A preferred binary rendition of a secondary color (such as blue in the subtractive colorant environment of printing) is achieved by alternating the primary colors in a dot-off-dot rendering. Alternating colorants achieves the appearance of low graininess and a larger gamut for producing higher frequency texture, relatively low contrast between a dot and white paper, and coverage of more white paper. Dot-on-dot rendering suffers from high graininess and a smaller gamut because it has lower frequency texture, higher contrast between a dot and the white background, and covers less white paper.

The binary image 730 resulting from the application of the vector halftoning/error diffusion method 400 is based on the same contone data 710 and results from the same sub-sampling decimation factor. However, he resulting binary image 730 contains the desirable attributes of significantly more instances of dot-off-dot pixels, high frequency texture and a low percentage of unmarked paper. Accordingly, this representation of an even blue patch has low contrast with the background within the area of the patch and reduced graininess.

The disclosed methods and systems may be implemented as computer or computational element based systems and methods. As such, the pixel data and all other data used herein may be input using any one of known computer data input interfaces such as, but not limited to, a keyboard, a disc drive, a network input feed, a digital camera or a copying scanner. Furthermore the input image may be generated through the use of image or document authoring software. The image data and related information may be stored on computer memory and may be formatted in a database structure queriable by SQL or any other database operable language. The data may be processed by one or more computer processor or computational element in real time or drawn from a memory. The processor may also be inside a network server or a router for moving data from one location or format to another location or format. Such a server or computer processor may also be employed to transform input color images into output color halftones. The various functional blocks (e.g., 150, 180, 182, 184, 186, 188, 280, 282, 284, 286, 288, 320) of the system 310 may be implemented in various combinations of hardware and software. Additionally, the various functions of the functional blocks can be provided in other architectures or arrangements. The arrangement shown is illustrative only

The above examples are merely illustrative of several possible embodiments of the present disclosure, wherein equivalent alterations and/or modifications will occur to others skilled in the art upon reading and understanding this specification and the annexed drawings. For example, spatial sub-sampling, and bit depth reduction are two forms of compression that can have very fast implementations, which is important for real-time image paths. However, other forms of image data compression and decompression, such as, for example jpeg and jpeg2000, can be used for resolution reduction and restoration.

In particular regard to the various functions performed by the above described components, assemblies, devices, systems, circuits, and the like, the terms including a reference to a “means” used to describe such components are intended to correspond, unless otherwise indicated, to any component, such as hardware, software, or combinations thereof, which performs the specified function of the described component, i.e., that is functionally equivalent, even though not structurally equivalent to the disclosed structure which performs the function in the illustrated implementations of the disclosure. In addition, although a particular feature of the disclosure may have been disclosed with respect to only one of several embodiments, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims such terms are intended to be inclusive in a manner similar to the term “comprising”.

It will be appreciated that various of the above-disclosed and other features and functions, or alternatives thereof, may be desirably combined into many other different systems or applications, and further that various presently unforeseen or unanticipated alternatives, modifications, variations or improvements therein may be subsequently made by those skilled in the art which are also intended to be encompassed by the following claims.

What is claimed is:

1. A method for quantizing color image data of an image, the method comprising:
selecting a target pixel data channel from a plurality of pixel data channels of the image data;
combining pixel data of the image with color error values generated from a vector halftoning of at least one previously processed pixel, thereby generating combined pixel data;
vector halftoning the selected target pixel data channel of the combined pixel data, according to pixel data of at least one non-target pixel data channel of the image, thereby transforming the color image data of the image into marking decisions for the target pixel data channel; and
diffusing color error produced in the vector halftoning process for combining with unprocessed pixels neighboring each respective vector halftoned pixel.

2. The method of claim 1 comprising:
resolution reducing pixel data of the at least one non-target pixel data channel of the image, thereby generating low resolution pixel data relative to a nominal resolution of the target pixel data channel;
transmitting pixel data of the image in the target pixel data channel at the nominal resolution;
transmitting the low resolution pixel data;
receiving the transmitted target colorant pixel data;
receiving the transmitted low resolution pixel data;
restoring the resolution of the low resolution pixel data to the nominal resolution, thereby providing arrangeable data in the at least one non-target channel to arrange with the nominal resolution data in the target pixel data channel;
arranging the arrangeable data with the target channel pixel data, thereby producing arranged pixel data; and
combining the arranged pixel data with the diffused color error thereby generating the combined pixel data.

3. The method of claim 1 comprising:
for each respective non-target pixel data channel of interest in the image data:
de-selecting the target pixel data channel as the target pixel data channel, thereby reclassifying the target pixel data channel as a previous target pixel data channel;
selecting, in turn, the respective non-target pixel data channel to be the target pixel data channel;
combining pixel data of the image with color error values generated from a vector halftoning of at least one previously processed pixel, thereby generating combined pixel data;
vector halftoning the selected target pixel data channel of the combined pixel data, according to pixel data of at least one non-target pixel data channel of the image or at least one previous target pixel data channel of the image, thereby generating marking decisions for the target pixel data channel; and
diffusing color error produced in the vector halftoning process for combining with pixel values of pixels unprocessed under the current target pixel data channel selection neighboring each respective vector halftoned pixel;
thereby determining a marking decision for each pixel data channel of interest of the image; and
printing a rendered version of the image based on the determined marking decisions.

4. The method of claim 1 wherein diffusing color error produced in the vector halftoning process comprises:
diffusing the color error according to a vector error diffusion process.

5. The method of claim 4 wherein diffusing the color error according to a vector error diffusion process comprises:
propagating the color error in a perceptual color space; and
converting the propagated error to a colorant-based machine-dependent color space.

6. The method of claim 5 wherein propagating the color error comprises:
propagating the color error in the L*a*b* color space.

7. The method of claim 1 wherein vector halftoning the selected target pixel data channel comprises:
vector halftoning the selected target pixel data using a 16×16 array of stochastically arranged thresholds having values ranging within the range of 0 to 255, non-inclusive.

8. The method of claim 2 wherein resolution reducing pixel data of the at least one non-target pixel data channel of the image comprises at least one of sub-sampling the at least one non-target pixel data channel and reducing the bit-depth of pixel values of the at least one non-target pixel data channel.

9. The method of claim 7 wherein vector halftoning the selected target pixel data using a 16×16 array of stochastically arranged thresholds having values ranging within the range of 0 to 255, non-inclusive comprises:
vector halftoning the selected target pixel data using a 16×16 array of stochastically arranged thresholds having values ranging within the range of 64 to 191 inclusive.

10. The method of claim 1 wherein vector halftoning the selected target pixel data channel comprises:
vector halftoning according to at least one of a successive fill method and a minimal overlap strategy.

11. A method for quantizing color image data of an image, the method comprising:
selecting a target pixel data channel from a plurality of pixel data channels of the image data;
transmitting pixel data of the image in the target pixel data channel at a nominal resolution;
resolution reducing pixel data of at least one non-target pixel data channel of the image, thereby generating low resolution pixel data relative to the nominal resolution of the target pixel data channel;
transmitting the low resolution pixel data;
receiving the transmitted target colorant pixel data;
receiving the transmitted low resolution pixel data;
resolution restoring the low resolution pixel data to the nominal resolution, thereby providing arrangeable data in the at least one non-target channel to arrange with the nominal resolution data in the target pixel data channel;
arranging the arrangeable data with the target channel pixel data, thereby producing aligned pixel data; and
combining the aligned pixel data with the diffused color error values generated from a vector halftoning of at least one previously processed pixel, thereby generating combined pixel data;
vector halftoning the selected target pixel data channel of the combined pixel data, according to pixel data of at least one non-target pixel data channel of combined pixel data, thereby transforming the color image data of the image into marking decisions for the target pixel data channel; and
diffusing color error produced in the vector halftoning process for combining with unprocessed pixels neighboring each respective vector halftoned pixel.

12. The method of claim 11 wherein vector halftoning the selected target pixel data channel comprises:
vector halftoning the selected target pixel data using a 16×16 array of stochastically arranged thresholds having values ranging within the range of 0 to 255, non-inclusive.

13. The method of claim 11 wherein resolution reducing pixel data of the at least one non-target pixel data channel of the image comprises at least one of sub-sampling the at least one non-target pixel data channel and reducing the bit-depth of pixel values of the at least one non-target pixel data channel.

14. The method of claim 12 wherein vector halftoning the selected target pixel data using a 16×16 array of stochastically arranged thresholds having values ranging within the range of 0 to 255, non-inclusive comprises:
vector halftoning the selected target pixel data using a 16×16 array of stochastically arranged thresholds having values ranging within the range of 64 to 191 inclusive.

15. A system for quantizing color image data of an image, the system comprising:
a vector halftoner that applies vector halftoning to a selected target pixel data channel of combined pixel data, according to pixel data of at least one non-target pixel data channel of the image, wherein the combined pixel data is generated by combining pixel data of the image with color error values generated from a vector halftoning of at least one previously processed pixel, thereby transforming the color image data of the image into marking decisions for the target pixel data channel; and
an error diffuser that diffuses color error produced in the vector halftoning process for combining with unprocessed pixels neighboring each respective vector halftoned pixel.

16. The system of claim 2 comprising:
a resolution reducer that reduces resolution of pixel data of the at least one non-target pixel data channel of the image, thereby generating low resolution pixel data relative to a nominal resolution of the target pixel data channel;
a pixel data transmitter that transmits pixel data of the image in the target pixel data channel at the nominal resolution and transmits the low resolution pixel data;
a pixel data receiver that receives the transmitted target colorant pixel data and the transmitted low resolution pixel data;
a resolution restorer that restores the resolution of the low resolution pixel data to the nominal resolution, thereby providing arrangeable data in the at least one non-target channel to arrange with the nominal resolution data in the target pixel data channel;
a pixel data arranger that arranges the arrangeable data with the target channel pixel data, thereby producing arranged pixel data; and
a pixel data combiner that combines the arranged pixel data with the diffused color error thereby generating the combined pixel data.

17. The system of claim 15 wherein the vector halftoner vector halftones the selected target pixel data channel by vector halftoning the selected target pixel data using a 16×16 array of stochastically arranged thresholds having values ranging within the range of 0 to 255, non-inclusive.

18. The method of claim 15 wherein the resolution reducer reduces the resolution of pixel data of the at least one non-target pixel data channel of the image by at least one of sub-sampling the at least one non-target pixel data channel and reducing the bit-depth of pixel values of the at least one non-target pixel data channel.

19. The method of claim 17 wherein the vector halftoner vector halftones the selected target pixel data using a 16×16 array of stochastically by vector halftoning the selected target pixel data using a 16×16 array of stochastically arranged thresholds having values ranging within the range of 64 to 191 inclusive.
